(19) United States
(12) Patent Application Publication
(10) Pub. No.: US 2008/0186194 A1
(43) Pub. Date: Aug. 7, 2008

(54) Dynamic condition monitoring system employing a multi-core processor

(75) Inventors: Benjamin Martin Kaminski, Cincinnati, OH (US); David J. Bibelhausen, Maineville, OH (US)

Correspondence Address: ROCKWELL AUTOMATION, INC./(FY), ATTENTION: SUSAN M. DONAHUE, E-7F19, 1201 SOUTH SECOND STREET, MILWAUKEE, WI, 53204, US

(73) Assignee: Rockwell Automation Technologies, Inc.

(21) Appl. No.: 11/540,243

(22) Filed: Sep. 29, 2006

(51) Int. Cl. G08B 21/00

(52) U.S. Cl. 340/683

(57) ABSTRACT

A dynamic condition monitoring system is disclosed for monitoring dynamic conditions such as vibration in a machine system. The monitoring system includes monitors coupled to sensors instrumenting the machine system. A multi-core processor in the monitors performs complex functions including managing exchange of data from the sensors and remote monitoring equipment, and analysis of the received signals, such as to derive vibration profiles via fast Fourier transform. Cores of the processor may be dedicated to such functions, or the cores may share responsibilities for the functions, such as through multithreading.

### BACKGROUND

The present invention relates generally to the field of systems for monitoring and protection of mechanical systems. More particularly, the invention relates to a technique for rapidly analyzing and responding to changing dynamic operating conditions of machine systems via a monitor that employs a multiple-core processor for performing monitoring functions and computations for such monitoring rapidly and in parallel.

In the field of industrial equipment monitoring and protection, a wide range of components and systems are known and presently in use. Depending upon the nature of the underlying mechanical system, the monitoring and protection components may generate various signals representative of dynamic conditions. The signal-generating components are typically sensors and transducers positioned on or otherwise closely associated with points of interest of the machine systems. The signals are applied to monitoring circuits, typically somewhat remote from the points of interest, and are used to analyze the performance of the machine system. Machine systems thus instrumented may include rotary machines, assembly lines, production equipment, material handling equipment, power generation equipment, as well as many other types of machines of varying complexity.

The rapidity of response to changing operating conditions is often an important factor in the utility of monitoring and protection systems. Where unwanted conditions appear, for example, alarms or alerts may be warranted, or it may even be desirable to shut down or start up portions of the machine system to prevent damage or to provide for servicing. The rapidity of response may be a function of the distance from ultimate controlling equipment, or of the design of the control scheme implemented, or of the complexity of processing necessary before a valid decision can be made as to the response to be taken to the detected conditions.

By way of example, one type of condition that may be monitored in rotary and other dynamic machine systems is vibration. Information indicative of vibration may be collected by accelerometers on or adjacent to points of interest of a machine, and conveyed to monitoring or control equipment. However, the information from the accelerometers is not typically useful in its raw form, and must be processed, analyzed, and considered in conjunction with other factors, such as operating speeds, to determine the appropriate response to existing or developing conditions.

Where complex analyses are to be performed on monitored signals, such as signals representative of vibration information, existing systems are in need of improvement. For example, traditional monitoring systems have made use of a single processor that was tasked with performing all monitoring and control functions, as well as the laborious computations needed for analysis. Improved monitors have used multiple processors, such as a main processor and a digital signal processor (DSP). This represented a significant improvement, insomuch as calculations that required substantial processing capabilities could be moved to the DSP.

However, further improvement is still needed. In particular, the use of multiple processors entails additional costs both of the components themselves as well as for mounting and interconnecting the components. Additional space is also required for the additional processor. Moreover, code must be tailored to separation of the processing functions and to communication of data to, from and between the processors. There remains a need, therefore, for improved dynamic condition monitors capable of very rapid operation, and providing complex analysis, such as of vibration profiles in monitored machine systems.

### BRIEF DESCRIPTION

The present invention provides a technique designed to respond to such needs. The technique is applicable in a wide range of settings, but is particularly well suited to monitors which are designed to be positioned in proximity to points of interest in a dynamic machine system, such as rotary equipment. However, the invention may also be applied to monitors that are placed remote from such points, as well as on “rack-based” systems and on “mobile” or hand-held monitors designed collect information from monitoring systems, such as during walkthroughs of facilities. Moreover, while the technique is susceptible to adaptation for a variety of monitors, it is particularly useful for monitoring applications in which very complex calculations must be made extremely rapidly, such as on monitored signals to derive vibration data, as well as in cases where speed of calculation is not critical to monitoring in itself, but where the time of users and operators is particularly valued, and where time spent waiting for processed results should be minimized.

In accordance with aspects of the technique, a monitor includes a multi-core processor. The multi-core processor is programmed to separately perform management functions of the monitor, such as communications traffic flow, memory utilization, and so forth, and calculations based upon received signals. Either of the cores may then execute code designed to report on or act upon the data resulting from the calculations. The actions may include controlling one or more components of the machine system with which the monitor is associated.

In a present implementation, the technique is applied to a vibration monitor. The single processor receives signals from one or more sensors or transducers, such as an accelerometer. The signals are analyzed to derive vibration data, such as a vibration profile over a range of operating speeds or frequencies of interest. One core of the single processor may then control integrated relay circuitry or separate relay circuitry in response to the vibration data, such as to energize or de-energize a portion of the machine system, sound an alarm, display an alert, and so forth, while the other core continues to acquire and process dynamic data of interest.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical overview of a machine system employing a multi-core processor monitoring and protection system in accordance with aspects of the present technique;

FIG. 2 is an exemplary topology for monitors and related equipment for use in a machine system of the type shown in FIG. 1;

FIG. 3 is a diagrammatical representation of a series of associated monitors in a group;

FIG. 4 is a diagrammatical representation of exemplary functional components of a multi-core processor monitor for performing and/or monitoring protection functions;

FIG. 5 is a diagrammatical representation of a first exemplary architecture for a multi-core processor which may be used in a monitor in accordance with the present techniques;

FIG. 6 is a diagrammatical representation of an alternative architecture for a multi-core processor for use with the invention; and

FIG. 7 is a diagrammatical representation for a further alternative architecture for the multi-core processor used in monitors in accordance with the invention.

### DETAILED DESCRIPTION

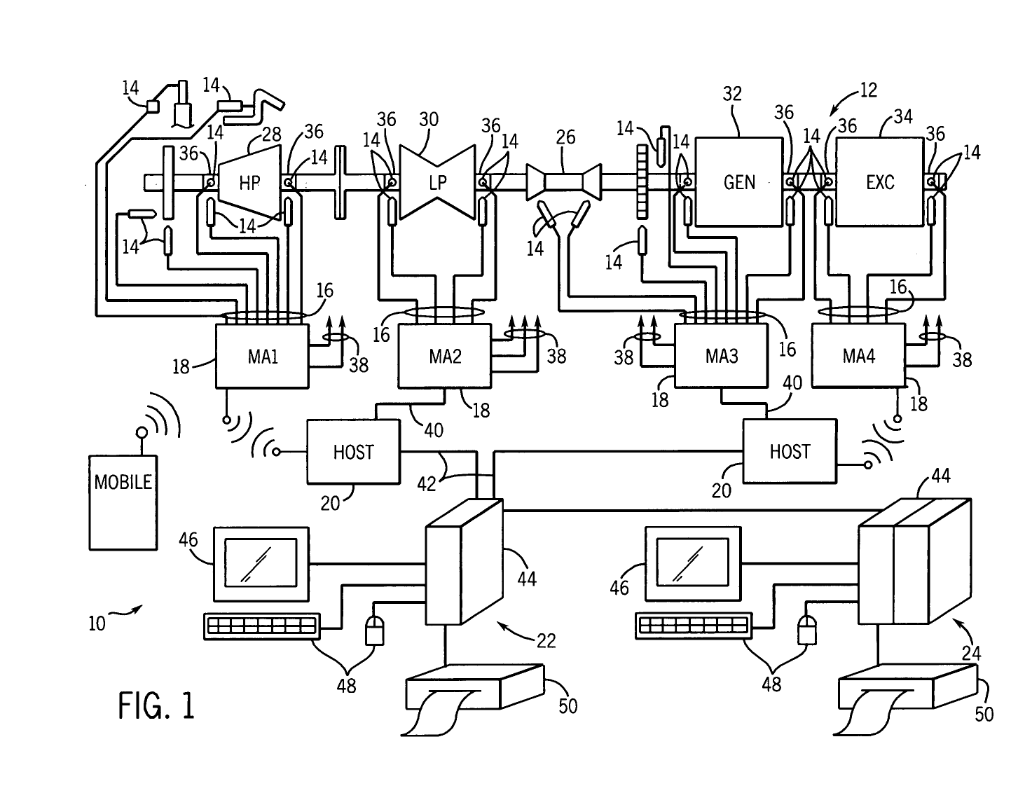

Turning now to the drawings, and referring first to FIG. 1, a diagrammatical overview is illustrated of a monitoring and protection system 10 applied to an exemplary machine system 12. The monitoring and protection system 10 is particularly well-suited for detecting, monitoring, and controlling a wide range of dynamic operating parameters of machine systems. In particular, the system is well-suited to various types of rotary equipment, although other applications may be envisaged for certain aspects of the present technique. As used herein, the term “dynamic operating condition,” or the reference to dynamic conditions in general, is intended to convey physical conditions or parameters of a machine system, as opposed, for example, to electrical conditions. The dynamic conditions may include such characteristics as vibration, rotation, speed, temperature, pressure, and so forth.

The monitoring and protection system 10 is designed to permit selective monitoring of dynamic operating conditions and parameters at various points along a machine system. In general, these points will correspond to locations at which such parameters can be sensed, and may be separated, independent or quite distal from one another. In the implementation illustrated in FIG. 1, for example, the mechanical system 12 generally represents a power generation system in which a wide range of dynamic operating conditions are monitored on a continual basis for informational, protection and control purposes. Accordingly, the monitoring and protection system 10 includes a series of sensors, detectors or transducers 14 mounted near or on various points of the machine system to detect the desired dynamic operating conditions. Communication lines 16 extend from the various sensors and transducers to monitors 18.

In accordance with the present invention, at least some of the assemblies or monitors 18 are equipped with multi-core processors, permitting them to process monitored data more quickly and efficiently, as summarized more fully below. In a present implementation, such monitors will include a multi-core processor, and code executed by the monitors may be specifically adapted for taking advantages of the unique pipelining and parallel processing capabilities of such multi-core processors. However, as multi-core processors with more than two cores on a single die become available, the invention is intended to encompass their use for dynamic condition monitoring applications as well.

The monitors may be placed proximate to, adjacent to, or relatively close to the various monitored locations or points, and need not be grouped as in certain heretofore known systems. Certain of the monitors, which will be described in greater detail below, may be linked via hosts 20. The hosts, or the monitors directly, may be linked to central or remote monitoring stations 22 and 24 both within a plant or installation, or remote from the plant or installation. Typically, the monitors 18 will be mounted closely adjacent to specific points or locations which are monitored, while hosts, if present, will be positioned near groups of monitors, or adjacent to a monitor. The central or remote monitoring station is typically provided in a desired plant location, such as a control room, for programming, monitoring, protection and control functions.

In the exemplary mechanical system 12 illustrated in FIG. 1, rotary shaft 26 links a series of functional sections of the system, including a high pressure turbine section 28, a low pressure turbine section 30, a generator 32 and an exciter 34. As will be appreciated by those skilled in the art, the shaft and various components of the system are supported by a series of bearings 36. Other components may clearly be included in the system, although the representation of FIG. 1 has been intentionally simplified for explanatory purposes.

Throughout the present discussion it should be borne in mind that the turbine mechanical system of FIG. 1 is simply an example of one application. The present technique may be applied in a wide range of industrial settings, including to material handling applications, pumping systems, fans, production equipment, assembly stations and lines, to name only a few. Moreover, the various components of the mechanical system need not be linked by single shafting, but may be disparate and linked only functionally in the overall system design. In the case of a turbine system, however, the various sensors, transducers, monitors, and other components of the system may form part of a turbine supervisory instrumentation system.

The various sensors and transducers 14 of the monitoring and protection system 10 may produce a wide range of signals based upon the detected dynamic operating conditions. Each generates one or more signals which is applied to monitors within each monitor 18 via the communication lines 16. The various transducers may be active or passive, and may receive power for operation via the communication lines. By way of example, the sensors and transducers of the instrumented turbine system of FIG. 1 may detect dynamic operating conditions such as valve position and case expansion, as indicated diagrammatically to the upper left in FIG. 1, eccentricity, bearing absolute casing vibration, both in X and Y directions, differential expansion, speed of rotation, rotational phase, and so forth. As will be noted by those skilled in the art, various sensors and transducers may be employed for these purposes, including linear variable differential transformers, non-contact pickups, rotary potentiometers, accelerometers, and so forth. Indeed, in a present implementation, the particular configuration of monitors within the monitors includes a specially adapted vibration monitor designed to be coupled to a tachometer and to an accelerometer. Such accelerometers may detect, for example, signals indicative of shaft, casing or pedestal vibration, depending upon the application.

The monitors 18 serve generally to receive, process, report and act upon the signals supplied by the sensors and transducers. For example, specific monitors within the assemblies may process input signals to produce vibration data which is used to analyze the performance or operating conditions of the mechanical system. Where desired, and as described more fully below, specific processing of this type may be implemented via the monitors of each or certain monitors, and closed-loop protection of the equipment may be provided, such as to energize or de-energize the components or a single component of the system. As will be appreciated by those skilled in the art, certain of the monitored dynamic operating conditions may be particularly indicative of abnormal and unwanted conditions, such as wear, impending failure, unbalance, excessive loading, and so forth. Also as described more fully below, certain of the monitors within the monitors may be designed to energize or de-energize an internal or external relay or similar switch to permit rapid control and protection functions. It should be noted that, as used herein, the term “relay” applies generally to a variety of switching devices which may be controlled by the monitors, such as conventional electromechanical devices, solid state devices, as well as other switching systems.

In addition to processing and analysis within the monitors, each monitor may generally provide outputs for external devices as indicated at reference numeral 38 in FIG. 1. The outputs may include electrical signals which can be applied to dedicated components, such as motors, alarms, lights, valves, and so forth. These outputs are generated based upon the monitoring and analysis functions performed by the monitors and, depending upon the programming of the various monitors, with input from remote devices such as the other monitor or a central or remote monitoring station.

Any particular configuration of the monitors may make use of the multi-core processing topology summarized below, including conventional backplane-based monitoring architectures. However, the monitors of the present technique make use of an open industrial data exchange protocol for the exchange of information both between monitors and may use the same protocol for the exchange of data with remote devices such as hosts and central or remote monitoring stations. As used herein, the term “open industrial data exchange protocol” generally refers to a non-proprietary and non-fee based scheme for formatting and transmitting data traffic between independent devices. A variety of such protocols have been developed and are presently available, including protocols designated generally in the industrial field as DeviceNet, ControlNet, Profibus and Modbus. Certain of such protocols may be administered by industry associations or bodies to ensure their open nature and to facilitate compliance with the protocol standards, such as the Open DeviceNet Vendors Association. It has been found that the use of a standard open industrial data exchange protocol for some or all of the communications between the monitors, between assemblies, and between remote devices and the monitors and assemblies, greatly enhances the interchangeability and applicability of the present system in various settings.

Due to the use of the open industrial data exchange protocol, the monitors, and the various monitors within the assemblies, may be linked to one another via standard network media 40, illustrated between the monitors 18 and the host 20 in FIG. 1. Similar media may be routed both within each monitor, and between assemblies. While any suitable media may be employed for this purpose, for data exchange only, a two-conductor or shielded cabling system may be employed. Where, as in the present system, data and power may be provided at certain locations, a conventional network media such as a four-conductor cable may be applied for network media 40. In the present embodiment, the media may include both power and data conductors disposed in a flat insulating jacket designed to interface the conductors with devices by conventional termination and by insulation displacement connectors. Further network media 42 serve to link the monitors or hosts with remote monitoring equipment. It should be noted that the media 40 and 42 may be identical where desired.

It should be noted, however, that as illustrated in FIG. 1, some or all of the communications between monitors, between the monitors and sensors, between the monitors and central monitoring stations or hosts, and even between sensors, may be made via wireless communications systems. For example, present wireless standards that satisfy the needs of the system might include ZIGBEE, IEEE 802.11, Bluetooth, and so forth. Other technologies that are presently suitable, or that may soon be suitable include cellular telephony techniques. For distant communications, the techniques may include point hopping technologies, in which monitors are scheduled to sleep and awaken to send and receive signals on a predetermined basis. Such techniques will allow for wireless communications at greater distances, and will also reduce the power required for driving the monitoring equipment and sensors.

It should also be noted that some or all of the functionality provided by the inclusion of a multi-core processor in the monitors, as described below, may be obtained in accordance with the invention in monitors that are not configured in a modular arrangement. Thus, conventional backplane-mounted and interconnected dynamic condition monitoring systems may similarly be equipped with multi-core processors and appropriate programming to take full advantage of the processing capabilities described below.

The various centralized or remote monitoring stations 22 and 24 may include any suitable equipment, such as general purpose or application-specific computers 44, monitors 46, interface devices 48, and output devices 50. Although simple computer systems are illustrated diagrammatically in FIG. 1, those skilled in the art will recognize that the centralized or remote monitoring stations may include highly complex analytical equipment, logging equipment, operator interface stations, control rooms, control centers, and so forth. As noted above, while at least one such monitoring station will typically be provided at or near the application, other stations may be provided entirely remote from the application, such as for monitoring plants, lines, production equipment, offshore facilities, and the like from entirely remote access points.

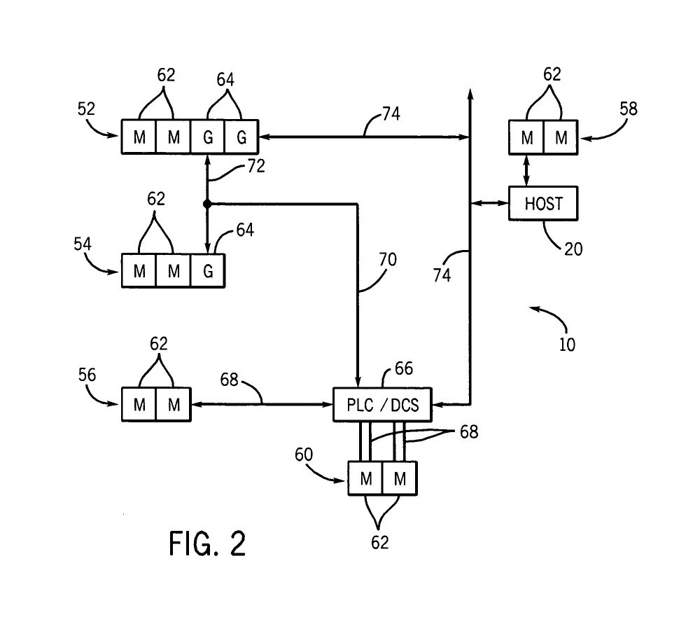

FIG. 2 illustrates an exemplary topology for a monitoring and protection system 10 in accordance with aspects of the present technique. In the topology of FIG. 2, modular monitors are associated in groups 52, 54, 56, 58 and 60. Each group may contain as few as a single monitor, and as many associated monitors as necessary at a desired point of interest of the machine system. Again, the individual monitors, designated generally by reference numeral 62 in FIG. 2, are designed to communicate data between themselves in accordance with an open industrial data exchange protocol, and are individually mounted and interfaced without the use of a conventional communications backplane (although the inventive use of multi-core processors could be implemented in conventional backplane systems as well, as noted above). The monitor groups may further include one or more gateways configured to receive or monitor signals from the monitors and to convey corresponding signals, in accordance with the same or a different data exchange protocol, to remote devices. For example, gateways 64 may afford data exchange in accordance with different open industrial data exchange protocols, enabling the use of multiple such protocols within the system, such as two or more of the protocols mentioned above. Other gateways may provide for easily interfacing external devices, including programmable logic controllers or digital control systems 66.

In the overall topology, then, certain of the monitors may be in direct communication with a remote or central monitoring and control station, such as a PLC or DCS 66, as indicated by data lines 68 in FIG. 2. Other communications may be provided to such devices as indicated at data lines 70, such as through branch lines 72 interconnected with appropriate gateways within the monitoring groups. Similarly, gateways 64 may provide for communication in accordance with further exemplary protocols, such as Ethernet or Internet protocols. Appropriate communications lines 74 are provided in these cases, and may be interfaced with the PLC or DCS 66 and with one or more hosts 20. In the case of Ethernet or Internet protocols, remote lines may be provided for data exchange with devices both within a facility and quite remote from the facility, such as via the Internet.

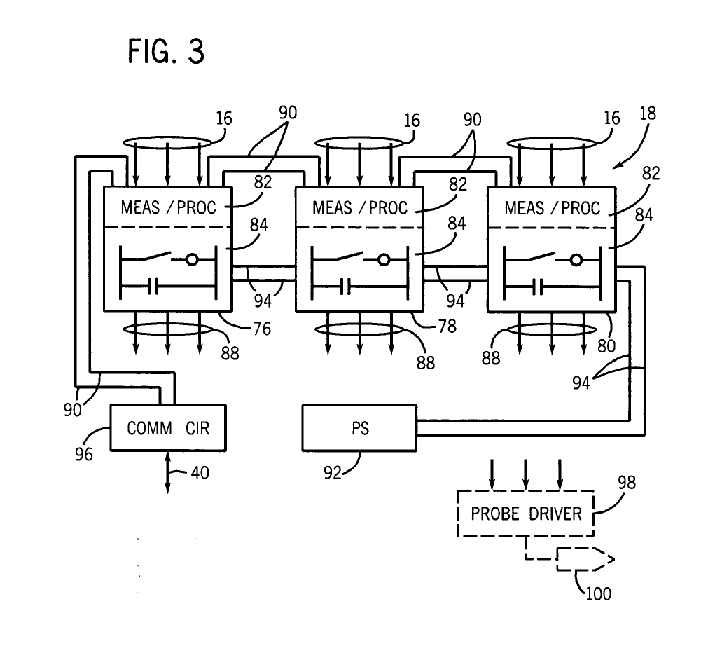

As mentioned above, in specific implementations, the monitors may perform desired measurement and processing functions, and may also serve to energize or de-energize components of the machine system. FIG. 3 illustrates diagrammatically several monitors within a monitoring group or assembly 18 of the type illustrated in FIG. 1. In the illustrated example, the monitor 18 includes a series of monitors 76, 78 and 80. Each of the monitors in the illustrated embodiment receives input signals at lines 16 and includes a corresponding signal processing section 82, and a relay portion 84. The processing section 82 includes circuitry for receiving, processing, and acting upon signals received from the various sensors and transducers. In a present implementation, for example, processing includes analysis of received signals for determination of vibration data, such as via a fast Fourier transform. As described more fully below, each monitor may include specialized multi-core processors and code adapted for these functions, as well as memory circuitry for storing configuration parameters in processing routines.

Based upon such processing, output signals may be produced and provided at output 88 in a manner described above, such as for controlling external relays, alarms, lights, LEDs, and other devices. At least certain of the monitors in a present embodiment further include an integrated relay 84 which may produce output signals in a similar manner, such as for completing or interrupting a current carrying path through a load, such as a motor control device, starter, valve, indicator light, alarm, and so forth. It has been found that integration of a relay directly in monitors which can be much closer to the actual monitored points of interest, affords extremely rapid response times. In particular, it has been found that conformity with industry standards for protective devices, such, as American Petroleum Institute (API) standard 670 can be met easily through the present monitoring system design and topology.

As mentioned above, to avoid the need for a conventional backplane, the monitors and monitors of the present system are designed to exchange data in accordance with an open industrial data exchange protocol. Indeed, this protocol is said to provide the “backbone” of the system, as opposed to the communication backplane of conventional systems. Accordingly, data links, represented generally by reference numeral 90 in FIG. 3 are provided between the monitors. Various physical configurations for such links may be envisaged. Conventional wiring may be provided, such as through terminated wires or insulation displacement-type connectors. In a present embodiment, however, data links are provided between the monitors by use of interconnecting terminal bases as described more fully below. Each individual monitor, then, is adapted for data exchange in accordance with the adopted protocol. The monitor 18 may further include power supply 92, typically providing constant voltage DC power, typically in the order of 24 volts. Alternatively, the media providing network links to the individual monitors may provide for power needs as well, such as through a power and data cable. Power supply lines 94 are routed to the individual monitors, such as through the interfaced terminal bases.

To permit routing of signals to external devices, one or more communications circuits 96 may be provided within the monitor. In the foregoing arrangements, for example, the communications circuit 96 included a gateway which may be used to communicate data to remote locations via the same open industrial data exchange protocol used between the monitors, or via a different protocol. It should be noted that a wide range of other devices may be provided in the assembly. The monitors themselves may be specifically adapted for certain functions, including vibration monitoring, speed monitoring, temperature monitoring, pressure monitoring, and so forth. Other devices may then include relay modules comprising one or more individual relay circuits controlled by the monitors, and probe drivers such as illustrated at reference numeral 98 in FIG. 3. Such probe drivers will typically provide power to probes or sensors 100 which are linked to the individual monitors.

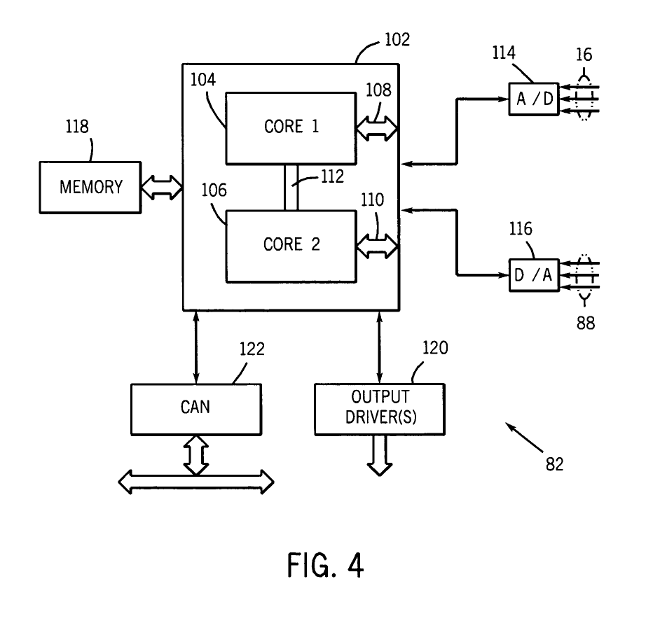

As noted above, the individual monitors include a circuitry designed to permit them to receive signals from sensors and transducers, and to process the signals and act upon the signals in accordance with predetermined routines. FIG. 4 illustrates an exemplary configuration of functional circuitry within a monitor in accordance with the present technique. As illustrated in FIG. 4, the monitor processing circuitry 82 includes a multi-core processor 102 having two processing cores 104, 106 on a single die. Such processors are commercially available from various sources, including Texas Instruments Inc. of Dallas, Tex., under the designation OMAP5910. The latter product provides two different cores on a single die, although the invention is not limited to architectures in which the cores are different, as described below. Such products may benefit from digital signal processor (DSP) and reduced instruction set computer (RISC) technologies.

As will be appreciated by those skilled in the art, dual, or more generally, multi-core processors enable particular load sharing benefits, particularly when used in conjunction with symmetrical multi-processing (SMP) or asymmetrical multi-processing (ASMP) software and environments. In addition, depending upon the processor and cores selected, and the software employed, multi-core processors may allow the monitors of the present invention to exhibit some form of thread-level parallelism (TLP) without including multiple microprocessors or DSP's in separate physical packages.

More particularly, certain currently available multi-core processors offer significantly reduced latency owing, at least in part, to direct connect architecture. Such arrangements directly connect the processing core to a memory controller, input/output, and to other processors. Moreover, the arrangement may make use of a system request queue capable of prioritizing flow of data into and from multiple processing cores. In presently contemplated embodiments, as described below, the monitoring and control code executed by the multi-core processor may be updated to function in accordance with SMP techniques, although the multi-core processors will function and remain back-compatible with existing code. As will be appreciated by those skilled in the art, SMP is a microprocessor computer architecture adapted for two or more identical processors coupled to a single shared main memory. SMP allows either or any processor on the die to work at any task, regardless of where the data for that task is located in memory. Thus, such architectures may move tasks between processors for improved balance of computing workload.

In a presently contemplated implementation, however, the cores of the multi-core processor need not be identical. That is, the monitors may attribute dedicated computing tasks to particular cores of the multi-core processor, employing ASMP techniques. This embodiment may entail a straightforward update to the basic real-time operating system (RTOS) from existing platforms, as well as modifications in software to appropriately direct tasks to the different cores of the multi-core processor. Such modifications are considered to be well within the purview of capable programmers based upon the descriptions provided herein.

As illustrated diagrammatically in FIG. 4, the multi-core processor 102 preferably includes multiple data links 108 and 110, enabling data to be more quickly transferred between the processor cores 104 and 106 and other components, such as cache and other memory. Similarly, a data connection 112 may be provided between the cores to allow for rapid exchange of input and output data. As will be appreciated by those skilled in the art, the use of multiple cores, particularly for carrying out the complex analysis of dynamic machine conditions (e.g., vibration analysis) will assist primarily through the ability to rapidly process instruction sets. Such instruction sets may be generally thought to include the functions of fetch, decode, execute, memory access and store. Fetching involves accessing memory that contains the program, while decoding involves reviewing fetched data to determine the type of instruction is used, and what data will be necessary to complete the instruction. Execution generally involves basic arithmetic and logic unit operations such as adding, multiplying, comparing, and so forth. Memory access is generally used by those instructions that call for storing information or load data to or extract data from memory.

The invention may also make use of pipelining to control and improve flow of operations to be performed by the cores of the multi-core processor 102. In general, as will be appreciated by those skilled in the art, pipelining typically entails adding registers between processing stages to hold the results of each individual stage. For example, after a core instruction completes a fetch stage, it may move to the decode stage while a second instruction initiates its fetch stage. It should be noted that, as described below, the present use of multiple cores may allow for both processing cores to share the burden of performing multiple tasks (e.g., of data flow management in the monitoring functions and calculations by fast Fourier transforms) via multithreading, or code may be written such that the two cores perform parallel processing designed to accomplish different functions (e.g., management versus calculations):

In a presently contemplated embodiment, the cores of the multi-core processor 102 are designed to carry out data management functions, to coordinate the exchange of data, and to control certain processing functions. An analog-to-digital converter 114 receives input signals as indicated at reference numeral 16, converts the input signals to digital signals and applies these signals to the multi-core processor 102. In a present embodiment, a 24 bit, 96 ksample/second converter provides extremely high resolution for the calculations made within the monitors, although other sampling rates may be employed. Similarly, a digital-to-analog converter 116 receives digital signals from the multi-core processor 102 and provides output signals as indicated at reference numeral 88, such as for monitoring, analysis or recording systems. A memory circuit 118 stores configuration parameters and codes, as well as routines implemented by the cores 104 and 106. Such routines may include analysis of received signals, such as to determine vibration data, including vibration profiles as described more fully below. The routines may also include code for analyzing and comparing data to preset alarm limits or advisory limits. Moreover, the processing code stored within memory circuit 118 may permit comparison of various signals or value levels, flags, alarms and alerts, and similar parameters within a single monitor or with signals received from other monitors or remote monitoring and control equipment, such as to define voting logic for energization or de-energization of devices within the system.

It should be noted that a wide variety of configuration parameters may be stored within each monitor. For example, sensor or transducer parameters may include the transducer type, its sensitivity, units of measure, low and high fault settings, DC bias time constants, and so forth. In vibration monitors, parameter settings may include such settings as channel name (for each of the multiple channels provided), output data units, high pass filter settings, full scale settings, sampling mode settings (e.g. synchronous or asynchronous), and so forth. Overall measurement parameters may also be set, such as for RMS calculations, peak calculations, peak-to-peak calculations, overall time constant calculations, damping factor calculations, as well as a range of spectrum and time waveform parameters. The latter may include values such as maximum frequency, number of lines or bins in spectrum measurements, period of waveforms, number of samples in waveform measurements, and window type (e.g. Hanning, rectangular, Hamming, flat top, and Kaiser Bessel). Band measurement parameters may also be set, such as RSS and peak signal detection settings, minimum and maximum frequencies in bands, and so forth. Similarly, various settings may be provided for speed or tachometer settings, such as for averaging, pulses per revolution, trigger mode, and so forth.

In accordance with a presently contemplated embodiment, certain dedicated processing may be done by one of the cores 104, 106 to enhance both the speed and the sharing of data between the cores. For example, one of the cores may be designated by software for carrying out certain analysis functions, such as vibration analysis. Vibration data is derived from signals received by the monitor. The analog-to-digital converter 114 receives conditioned signals and applies these signals to the multi-core processor 102. Dedicated processing can be performed on the signals by one of the cores, such as by application of analysis routines which may include a fast Fourier transform to establish a vibration profile over a range of speeds or frequencies of interest.

In this contemplated embodiment, the other core may perform functions such as control of communications, including control of data traffic over a bus, serial communications, such as for configuration of the monitor and memory circuitry, controls utilization of memory, and processes data from the other core. The second core may also control such functions as powering up and powering down devices, and control of a relay circuit, or other internal or external device.

Other circuitry which may be provided within the monitors includes driver circuitry 120 for devices such as an internal or external relay. While such circuitry may also be complimented by external circuitry, such as individual relay modules as discussed above, the provision of an internal relay circuit allows the monitor to perform extremely rapid, locally closed-loop protective functions. Code stored within memory circuit 118 and executed by the cores of the multi-core processor 102 may include local comparisons of processed data, such as vibration data, speed data, temperature data, pressure data, and so forth, to pre-set or operator-configurable limits or ranges. Where such a limit is reached, extremely rapid response may be provided by the integrated relay circuitry, the state of which can be quickly altered by output from the multi-core processor to the drivers 120.

The cores of multi-core processor 102 may also implement code which causes a change in the state of such relay circuitry in response to signals received from remote sources such as other monitors and central processing circuits. Effectively, then, the monitors may implement protection or control loops at several levels. Firstly, at a local level, the multi-core processor 102 may alter the operating state of a relay circuit extremely rapidly due to detected changes in operating conditions and by comparison with desired levels or ranges. In a broader, more remote control loop, input signals may be processed and analyzed at least partially remotely, with commands for operation of the relay circuitry being transmitted from the remote location and simply implemented by the multi-core processor or implemented by one of the cores of the processor in conjunction with locally-produced analytical data.

Communications circuitry, such as control area network circuitry 122 is preferably included in each monitor to permit the formatting, transmission, and reception of data in accordance with the desired protocols. As noted above, the present monitors preferably communicate with other monitors and with external circuitry via an open industrial data exchange protocol.

As mentioned above, a present implementation of the techniques and monitor designs discussed herein accommodates analysis of vibration data. Such vibration data may be a key component in mechanical system monitoring, control and protection. In a present implementation, vibration profiles are generated in dedicated vibration monitors based upon multiple channels of signal acquisition, from accelerometers and tachometers. The circuitry within the vibration monitors performs any suitable analysis to generate vibration data, which may be presented as a vibration profile. Alarm or alert ranges, limits, levels, and the like may be established and combined with the vibration data for monitoring, protection and control functions both within the monitor and in conjunction with other monitors and control devices.

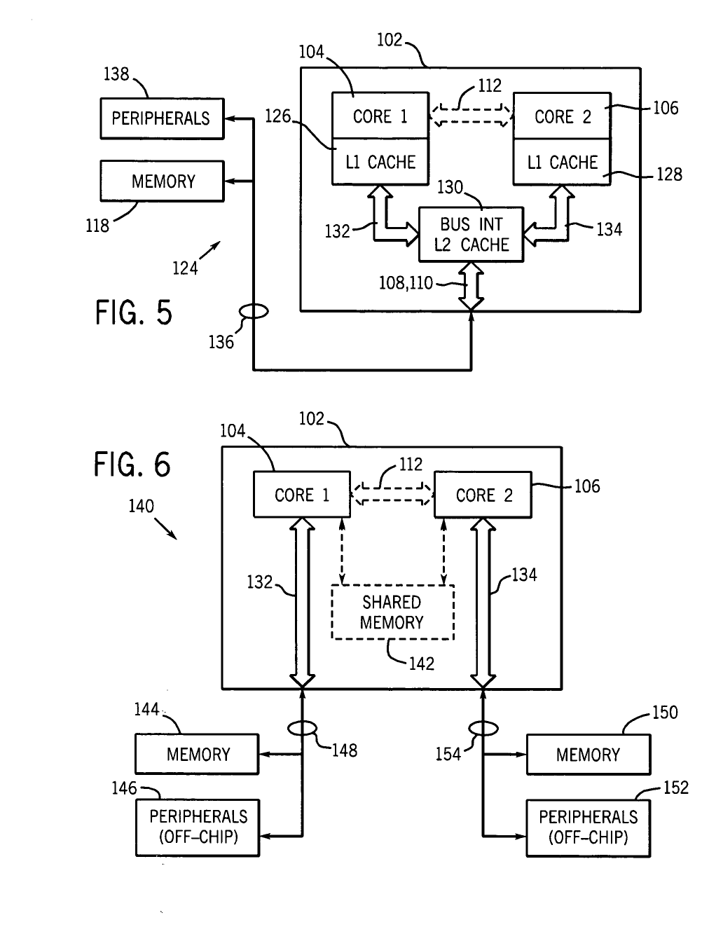

As noted above, several alternative architectures for a multi-core processor may be employed in accordance with present technique. FIGS. 5, 6 and 7 represent certain presently contemplated architectures. As shown first in FIG. 5, a multi-core processor arrangement 124 may include multiple cores 104 and 106 on a common die 102. In this embodiment, the cores 104 and 106 may be similar to one another or the same, and each is served its own cache memory 126 and 128, respectively. As will be appreciated by those skilled in the art, these memory components serve to store the immediate next instruction to be executed by each of the cores. Moreover, the two cores may share a common bus interface with further cache memory, as indicated by reference numeral 130, coupled to the cores via data buses 132 and 134. Such memory will store further instructions for tasks which may be performed by either core 104 or core 106. The cores may have an optional data connection 112 for the exchange of information directly between the cores as noted above.

In the architecture of FIG. 5, the multi-core processor 102 is coupled to shared memory and peripherals by means of a data bus 136. In general, memory 118 may store execution or program data, while peripherals 138 may include such components as A/D converters, D/A converters, UART, memory, and so forth.

The alternative architecture of FIG. 6, designated generally by reference numeral 140, similarly includes a plurality of cores 104 and 106 on a common die 102. In this arrangement, however, the cores are independent. That is, each core 104 and 106 has a separate data bus 132 and 134 for communicating between the respective core and external (off-chip) circuits. The cores may, as noted above, share information therebetween, where desired, via a data connection 112. Moreover, the cores may also share memory 142 which may be provided on the die 102.

In the architecture 140, however, each core will generally be coupled to separate memory 144 and 150, respectively, and have its own off-chip peripherals 146 and 152, respectively. Accordingly, data buses 148 and 154 will be coupled to the individual, independent cores for receiving instructions, transmitting data, and so forth. The architecture illustrated in FIG. 6 may be particularly well-suited to asymmetrical designs in which each core executes instructions and performs tasks which are dedicated to that core.

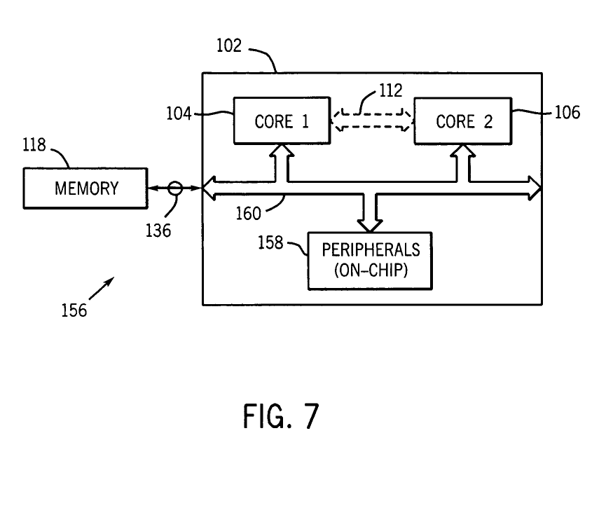

FIG. 7 illustrates a further possible architecture, indicated generally by reference numeral 156. Here again, a plurality of cores 104 and 106 are provided on a common die 102. Here, however, on-chip peripherals 158 are provided, which may include A/D converters, D/A converters, memory, and so forth. Communications may be had directly between the cores, as indicated generally by reference numeral 112, as before. Moreover, a data bus 160 is provided on the die for communicating with the cores and the peripherals, as well as with external circuits, such as memory 118. The architecture of FIG. 7 may also be suitable for asymmetrical computing in which the cores have specific instructions and tasks to be performed.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A dynamic condition monitoring system comprising:
a dynamic condition monitor configured to be coupled to at least one sensor for detecting a dynamic condition of a machine system and to receive signals from the sensor representative of the dynamic condition; and
a multi-core processor operative in the monitor for receiving data derived from the signals and for performing dynamic condition analysis based upon the received signals.

2. The system of claim 1, wherein the processor includes two cores coupled to one another for data exchange therebetween.

3. The system of claim 1, wherein a first core performs dedicated functions including managing at least transmission of data to a remote device, and a second core performs dedicated functions of receiving and processing signals from a sensor representative of a dynamic operating parameter of the machine system.

4. The system of claim 3, wherein the first or second core is configured to perform computations based on the received signals and configuration parameters stored in a memory circuit.

5. The system of claim 4, wherein the computations performed by the second core include a fast Fourier transform.

6. The system of claim 5, wherein the fast Fourier transform derives vibration data from the received signals.

7. The system of claim 6, wherein at least one of the first and second cores is configured to output an alarm signal based upon the vibration data.

8. The system of claim 1, wherein the cores of the processor execute instructions in accordance with symmetrical multi-processing.

9. A dynamic condition monitoring system comprising:
a dynamic condition monitor configured to be coupled to at least one sensor for detecting a dynamic condition of a machine system and to receive signals from the sensor representative of the dynamic condition; and
a multi-core processor operative in the monitor for receiving data derived from the signals and for performing dynamic condition analysis based upon the received signals, at least one core of the multi-core processor being dedicated to perform vibration analysis based upon the signals to the exclusion of at least one other core.

10. The monitor of claim 9, wherein the cores of the processor are dissimilar, and execute instructions in accordance with asymmetrical multi-processing.

11. A monitor for monitoring dynamic operating parameters of a machine system, the monitor comprising:
a sensor interface for receiving signals from a sensor representative of a dynamic operation parameter of the machine system;
a memory circuit for storing configuration parameters of the monitor;
a multi-core processor coupled to the interface and to the memory circuit, the processor being configured to manage at least transmission of data to a remote device, and to receive the signals and perform computations based on the received signals and the configuration parameters stored in the memory circuit, including a fast Fourier transform of the signals to derive vibration data from the received signals.

12. The monitor of claim 11, wherein the processor includes two cores coupled to one another for data exchange therebetween.

13. The monitor of claim 11, wherein the cores of the processor execute instructions in accordance with symmetrical multi-processing.

14. The monitor of claim 11, wherein the cores of the processor are dissimilar, and execute instructions in accordance with asymmetrical multi-processing.

15. The monitor of claim 11, wherein the processor is configured to output an alarm signal based upon the vibration data.

16. The monitor of claim 11, wherein the managing function is dedicated to be performed by a first core, and the computation function is dedicated to be performed by a second core.

17. A modular monitoring system for monitoring dynamic operating parameters of a machine system, the monitoring system comprising:
a plurality of sensors for detecting dynamic operating parameters of the machine system at a desired location and for generating signals representative thereof; and
a plurality of monitors, each monitor being coupled to at least one sensor and including a memory circuit for storing configuration parameters of the monitor and a multi-core processor coupled to receive data from at least one sensor and from the memory circuit, multiple cores of the processor being configured to manage at least transmission of data to a remote device, and to perform computations based on the received signals and the configuration parameters stored in the memory circuit, including a fast Fourier transform of the signals to derive vibration data from the received signals.

18. The system of claim 17, wherein each processor includes two cores coupled to one another for data exchange therebetween.

19. The system of claim 17, wherein the cores of each processor execute instructions in accordance with symmetrical multi-processing.

20. The system of claim 17, wherein the cores of the processor are dissimilar, and execute instructions in accordance with asymmetrical multi-processing.

21. The system of claim 17, wherein the sensors include accelerometers and tachometers.

22. The system of claim 17, wherein at least one of the monitors is configured to derive vibration related data based upon signals received from sensors to which it is coupled and upon signals from sensors from other monitors.

23. A dynamic condition monitoring system comprising:
a portable dynamic condition monitor configured to receive signals from sensors or from condition monitors coupled to sensors, the sensors detecting a dynamic condition of a machine system; and
a multi-core processor operative in the portable monitor for receiving data derived from the signals and for performing dynamic condition analysis based upon the received signals.

24. The system of claim 23, wherein the portable dynamic condition monitor is configured to receive data from the sensors or from the monitors via a wireless data communications protocol.
